(19) United States
(12) Patent Application Publication
(10) Pub. No.: US 2005/0162844 A1
(43) Pub. Date: Jul. 28, 2005

(54) Luminescent snowboard

(76) Inventor: Bae Yun-Ki, Seoul (KR)

Correspondence Address: VENABLE LLP, P.O. BOX 34385, WASHINGTON, DC, 20045-9998, US

(21) Appl. No.: 10/508,877

(22) PCT Filed: Dec. 10, 2002
(86) PCT No.: PCT/KR02/02329

(30) Foreign Application Priority Data
Mar. 29, 2002 (KR) 20-2002-0009501

(51) Int. Cl. F21K 2/00

(52) U.S. Cl. 362/34

(57) ABSTRACT

The present invention relates to the luminescent snowboard having the permanent magnet rotated by the movement of the snowboard and induction coil located in the around of the permanent magnet, wherein, the rotation of the permanent magnet generate the induction current on the induction coil, and, this induction current is the electric source of the luminescent snowboard.

### TECHNICAL FIELD

The present invention relates to the luminescent snowboard having the permanent magnet rotated by the movement of snowboard and induction coil located around the permanent magnet, wherein, the rotation of the permanent magnet generate the induction current on the induction coil, and this induction current is the electric source of the luminescent snowboard.

### BACKGROUND ART

Generally, a snowboard slides at a high speed, and a snowboarder wears a bright color ski clothes and a goggle for implementing a certain field of vision for thereby preventing a certain crash accident.

However, when a user plays snowboarding at night, since a skin gear is not recognized at night, an accident may be increased. Even when a safety staff stands by, it is impossible to prevent an accident.

### DISCLOSURE OF INVENTION

Overcoming the problems encountered in the conventional art, the object of the present invention is to provide a luminescent snowboard which is implementing a certain decoration effect and which is easily recognized at night by providing a luminescent unit.

It is another object of the present invention to provide a luminescent snowboard which does not need an additional operation such a switch operation or a battery exchange that a luminescent unit is blinked using a current which is generated by a movement of a snowboard.

In order to achieve the above objects of the present invention, a luminescent snowboard, comprising: a permanent magnet which is rotatably installed in an upper portion of the deck by a rotation wing having the same rotary shaft; an induction coil which is fixedly installed in a surrounding portion of the permanent magnet; and a luminescent unit with light emitting diode which is connected with an extension of the induction coil.

In order to achieve another object of the present invention, the permanent magnet, induction coil and luminescent diode are installed inside the housing which is combined with the upper of the deck.

In order to achieve another object of the present invention, the upper of the housing includes transmission windows through which a light of the light emitting diode transmits to the outside.

### BRIEF DESCRIPTION OF THE DRAWINGS

The present invention will become better understood with reference to the accompanying drawings which are given only by way of illustration and thus are not limitative of the present invention, wherein;

FIG. 1 is a front diagram illustrating a luminescent snowboard according to an embodiment of the present invention;

FIG. 2 is a sectional diagram of I-I line of FIG. 2 according to the present invention;

FIG. 3 is a diagram illustrating the construction of a permanent magnet according to the present invention.

<Descriptions of reference numerals of major
elements of the drawings>

| | | | |
|---|---|---|---|
| 10: | deck | 20: | luminescent unit |
| 21: | housing | 22: | rotation wing |
| 23: | rotary shaft | 23a: | supporting part |
| 23b: | bearing | 24: | permanent magnet |
| 25: | induction coil | 26: | light emitting diode |
| 27: | transmission window | | |

### PREFERRED EMBODIMENT

The preferred embodiments of a luminescent snowboard according to the present invention will be described with reference to the accompanying drawings.

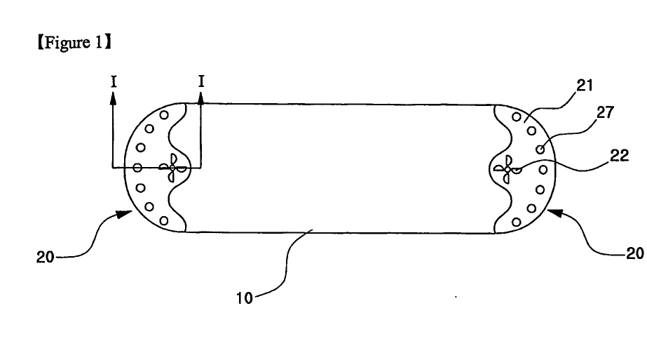

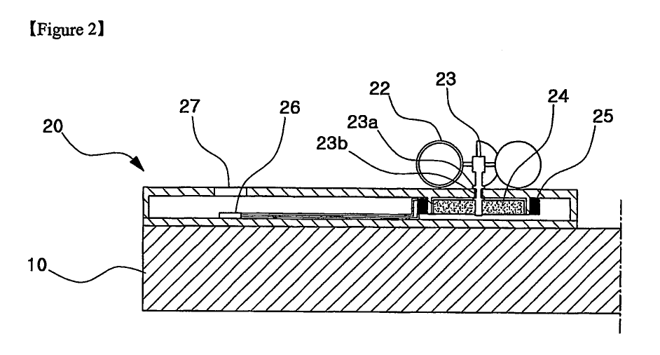

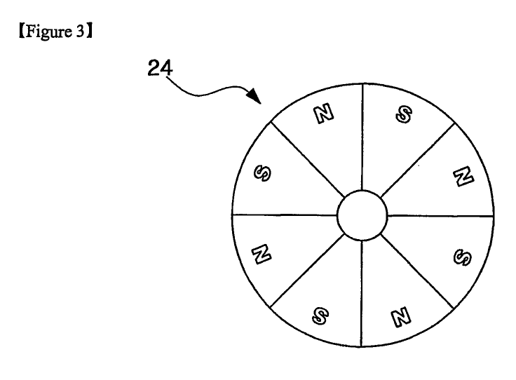

FIG. 1 is a front diagram illustrating a luminescent snowboard according to the present invention, FIG. 2 is a sectional diagram of I-I line of FIG. 2 according to the present invention and FIG. 3 is a diagram illustrating the construction of a permanent magnet according to the present invention.

The luminescent snowboard comprises two luminescent units (20) which is combined with both side of the deck (10).

The luminescent unit (20) is formed of a housing (21), a rotation wing (22), a rotary shaft (23), a permanent magnet (24), an induction coil (25), and light emitting (26).

The housing (21) is combined with one of the upper side of the deck (10). The interior of the housing (21) is installed the permanent magnet (24), the induction coil (25), and the light emitting diode (26) and the upper of the housing (21) is formed of a plurality of circular transmission window (27) through which the light of the light emitting diode (26) is transmitted to the outside.

The rotation wing (22) is provided in an end outer surface of the rotary shaft (23) and is rotated by wind, and a plate or a propeller-shaped wing which is slanted in a certain direction is formed in an outer surface of the rotary shaft (23) in a radial direction.

The rotary shaft (23) forms a rotation center axis of the rotation wing (22) and passes through one side of the housing (21) in parallel and is engaged with the permanent magnet (24) in the interior of the housing (21). In addition, as shown in FIG. 2, a supporting part (23a) is formed in an outer surface of the rotary shaft (23) in order for the rotary shaft (23) to be moved in a vertical direction. In addition, a bearing (23b) is installed for implementing a smooth operation of the rotary shaft (23).

The permanent magnet (24) is vertically installed in the interior of the housing (21) in such a manner that the permanent magnet (24) is rotatable about a center axis of the rotary shaft (23). As shown in FIG. 3, N-pole and S-pole are alternately formed in an outer surface of the same, and a through hole engaged with the rotary shaft (23) is formed in a same inner surface for thereby forming a circular shape. At this time, a rotational force of the rotation wing (22) is transferred as a rotation force of the permanent magnet (24) through the rotary shaft (23).

The induction coil (25) is installed in the interior of the housing (21) fixedly with a certain width from the permanent magnet (24) and generates an induction current by an induction electromotive force which is generated by a variation of a magnetic force by a rotation movement of the permanent magnet (24).

The light emitting diode (26) is installed the interior of the housing (21) so as to connect with the extension of the induction coil (25), and lighted by the induction current generated in the induction coil (25).

The light emitting diode (26) may be formed of a plurality of luminescent diodes which emit various color light or may be formed in such a manner that the transmission window (27) generates various colors for thereby enhancing a visional effect. A reflection plate may be installed in a lower portion of the light emitting diode, so that the luminescent is more visible by a blinking operation of the luminescent diodes (26).

The luminescent operation of the luminescent snowboard according to the present invention will be described below.

When a user snowboards on a slope, riding on a luminescent snowboard, the rotation wing (22) installed the both side of snowboard is rotated by wind, and a driving force of the rotation wing (22) is transferred to the permanent magnet (24) through the rotary shaft (23), and the rotation wing (22) and the permanent magnet (24) are rotated together.

As the permanent magnet (24) is rotated, an induction current is generated in the induction coil (25) by a variation of the magnetic force of the N-pole and S-pole alternately formed in an outer surface of the permanent magnet (24). The generated induction current is applied to the light emitting diode connected with an extension of the induction coil (25), so that the light emitting diodes are lighted.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

### Industrial Applicability

As described above, in the present invention, a luminescent unit is provided in a snowboard for thereby implementing a certain visible decoration effect and preventing a possible crash accident with a good recognition at night.

In addition, in the present invention, the luminescent unit of a snowboard is blinked by a sliding operation of snowboard without providing an additional power apparatus such as a battery, etc. and without operating a switch, so that it is convenient to use the same.

1. In a snowboard, luminescent snowboard, comprising:
a permanent magnet which is rotatably installed in an upper portion of the deck by a rotation wing having the same rotary shaft;
an induction coil which is fixedly installed in a surrounding portion of the permanent magnet; and
a luminescent unit with a light emitting diode which is connected with an extension of the induction coil.

2. The luminescent snowboard as recited in claim 1, wherein the permanent magnet, induction coil and luminescent unit are installed inside of the housing combined with the upper of the deck.

3. The luminescent snowboard as recited in claim 2, wherein the upper of the housing includes transmission windows through which a light of the light emitting diode transmits to the outside.
